(19) United States
(12) Patent Application Publication
(10) Pub. No.: US 2009/0066820 A1
(43) Pub. Date: Mar. 12, 2009

(54) FILTERING OPTIMIZATION VIA IMPLICIT BAYER GRID SUBSAMPLING

(75) Inventors: Wenqing Jiang, San Jose, CA (US); Ying Cao, San Jose, CA (US); Li Hao, Cupertino, CA (US); Weiping Pan, San Jose, CA (US)

Correspondence Address: FIALA & WEAVER, P.L.L.C.;C/O INTELLEVATE, P.O. BOX 52050, MINNEAPOLLS, MN, 55402, US

(73) Assignee: BROADCOM CORPORATION, Irvine, CA (US)

(21) Appl. No.: 11/850,962

(22) Filed: Sep. 6, 2007

(51) Int. Cl. H04N 9/04

(52) U.S. Cl. 348/273; 348/E09.002

(57) ABSTRACT

Methods, systems, and apparatuses for filtering captured image data are provided. An array of pixel data values corresponding to a captured image is received. The pixel data values in the received array are pixel data values of a first color of the captured image. A filter function is performed on a portion of the pixel data values of the array that are located in Bayer pattern pixel locations of the array for the first color. Subsequent arrays of pixel data values corresponding to further colors of the captured image may be received and filtered in a similar manner. Furthermore, further captured images in a video stream may be received and filtered in a similar manner, to generate a stream of filtered video images.

### BACKGROUND OF THE INVENTION

1. Field of the Invention

The present invention relates to image data filtering.

2. Background Art

An increasing number of devices are being produced that are enabled to capture and display images. For example, mobile devices, such as cell phones, are increasingly being equipped with cameras to capture images, including still snapshots and motion video images. Images captured by such devices can frequently be viewed on displays of the devices, as well as being transferred from the devices for viewing elsewhere. To view the images on relatively small devices, the images typically must be viewed on small display screens that are not capable of viewing the full resolution of the captured images. Thus, such devices must include at least limited image processing capability to down-size the images for viewing on the small display screens.

Many mobile devices have limited processing capability due to cost, power consumption, and size constraints. However, the processing of captured images, especially the processing of video, is very computationally intensive. For example, many mobile devices have cameras capable of capturing images of 2 MegaPixels (MPel) or more. Thus, a processor of such a mobile device must be capable of processing a large amount of data for each captured image. Furthermore, encoding and decoding (e.g., QCIF) of image data may need to be performed by the processor at frame rates such as 15 fps and 30 fps, respectively, as well as the performance of other functions.

To deal with such high-resource demanding tasks, mobile device developers have resorted to including high-powered processing chips in the devices, which have higher clock rates and larger on-chip cache memory, or to including dedicated video/image processing chips. Such approaches result in higher cost devices with higher levels of power consumption, which may not be desirable in battery powered mobile devices.

Thus, ways are desired for handling an image processing workload in devices, such as mobile devices, without significantly raising device costs and power consumption levels.

### BRIEF SUMMARY OF THE INVENTION

Methods, systems, and apparatuses are described for processing captured image data in devices. Images are captured by an image sensor in the form of an array of multi-color image data, formatted according to a standard image data format (e.g., such as a Bayer pattern). The array of standard format image data is typically processed into multiple separate arrays, with each separate array directed to a different color. In aspects of the present invention, filtering operations are performed on one or more of the generated multiple separate arrays of image data. When filtering such an array, selected pixel data in the array is not used. For example, the selected pixel data may be ignored or discarded. As a result, the filtering operations can be performed on fewer pixel data values of the array, and therefore may require fewer calculations. Furthermore, the filtering operations may have a filtering outcome that is equal to or even better in quality than for conventional filtering operations.

For instance, in a first example, an array of pixel data values corresponding to a captured image is received. The pixel data values in the received array are pixel data values of a first color of the captured image. A filter function is performed on a portion of the pixel data values of the array that are located in Bayer (or other pattern/color filter array) pattern pixel locations of the array for the first color. Subsequent arrays of pixel data values corresponding to further colors of the captured image may be received and filtered in a similar manner. Furthermore, further captured images in a video stream may be received and filtered in a similar manner, to generate a stream of filtered video images.

In another example, an image filtering system is provided. The image filtering system includes a data extractor and an image data filter. The data extractor is optional. When present, the data extractor is configured to receive an array of pixel data values corresponding to a captured image. The pixel data values in the array are pixel data values of a first color of the captured image. The data extractor is configured to extract a portion of the pixel data values of the array corresponding to pixel filter locations configured to pass the first color in a color filter array (CFA). The image data filter is configured to perform a filter function on the extracted portion of the pixel data values of the array.

In a further aspect, when the data extractor is not present, the image data filter is configured to receive the array of pixel data values corresponding to the captured image, and to perform the filter function on the portion of the pixel data values of the array corresponding to pixel filter locations configured to pass the first color in a color filter array (CFA).

These and other objects, advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a block diagram of an example mobile device with image capture and processing capability.

FIG. 2 shows a sensor array of an example image sensor device, having a two-dimensional array of pixel sensors.

FIG. 3 shows a block diagram representation of image data included in an image signal for an image captured by an image sensor device.

FIG. 4 illustrates image data in array form, as captured by an image sensor.

FIG. 5 shows example red, green, and blue color channels generated by an image processor from image data.

FIG. 6 shows an image data word formatted according to a standard implementation, containing 16-bits and including red, green, and blue color channel data.

FIG. 7 shows a block diagram representation of image downsizing.

FIG. 8 shows a flowchart providing example steps for capturing and processing image data, according to an example embodiment of the present invention.

FIG. 9 shows an example Bayer color filter array (CFA) which may be used to generate image data according to a Bayer pattern.

FIG. 10 shows a flowchart providing example steps for filtering a captured image, according to an example embodiment of the present invention

FIG. 11 shows a red portion, a green portion, and a blue portion of pixel data values of a captured image corresponding to a Bayer CFA.

FIG. 12 shows a block diagram of an image filtering system, according to an embodiment of the present invention.

FIG. 13 shows a flowchart providing example steps for subsampling an array of pixel data values to generate a down-scaled array, according to an embodiment of the present invention.

FIG. 14 shows a block diagram of an example segmented array of pixel data values, according to an embodiment of the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

### Image Processing in Mobile Devices

Embodiments of the present invention relate to image processing performed in devices. For example, embodiments include mobile devices where image processing must be performed with limited resources. Types of such mobile devices include mobile phones (e.g., cell phones), handheld computing devices (e.g., personal digital assistants (PDAs), BLACKBERRY devices, PALM devices, etc.), handheld music players (e.g., APPLE IPODs, MP3 players, etc.), and further types of mobile devices. Such mobile devices may include a camera used to capture images, such as still images and video images. The captured images are processed internal to the mobile device.

FIG. 1 shows a block diagram of an example mobile device 100 with image capture and processing capability. Mobile device 100 may be a mobile phone, a handheld computing device, a music player, etc. The implementation of mobile device 100 shown in FIG. 1 is provided for purposes of illustration, and is not intended to be limiting. Embodiments of the present invention are intended to cover mobile devices having additional and/or alternative features to those shown for mobile device 100 in FIG. 1.

As shown in FIG. 1, mobile device 100 includes an image sensor device 102, an analog-to-digital (A/D) 104, an image processor 106, a speaker 108, a microphone 110, an audio codec 112, a central processing unit (CPU) 114, a radio frequency (RF) transceiver 116, an antenna 118, a display 120, a battery 122, a storage 124, and a keypad 126. These components are typically mounted to or contained in a housing. The housing may further contain a circuit board mounting integrated circuit chips and/or other electrical devices corresponding to these components. Each of these components of mobile device 100 is described as follows.

Battery 122 provides power to the components of mobile device 100 that require power. Battery 122 may be any type of battery, including one or more rechargeable and/or non-rechargeable batteries.

Keypad 126 is a user interface device that includes a plurality of keys enabling a user of mobile device 100 to enter data, commands, and/or to otherwise interact with mobile device 100. Mobile device 100 may include additional and/or alternative user interface devices to keypad 126, such as a touch pad, a roller ball, a stick, a click wheel, and/or voice recognition technology.

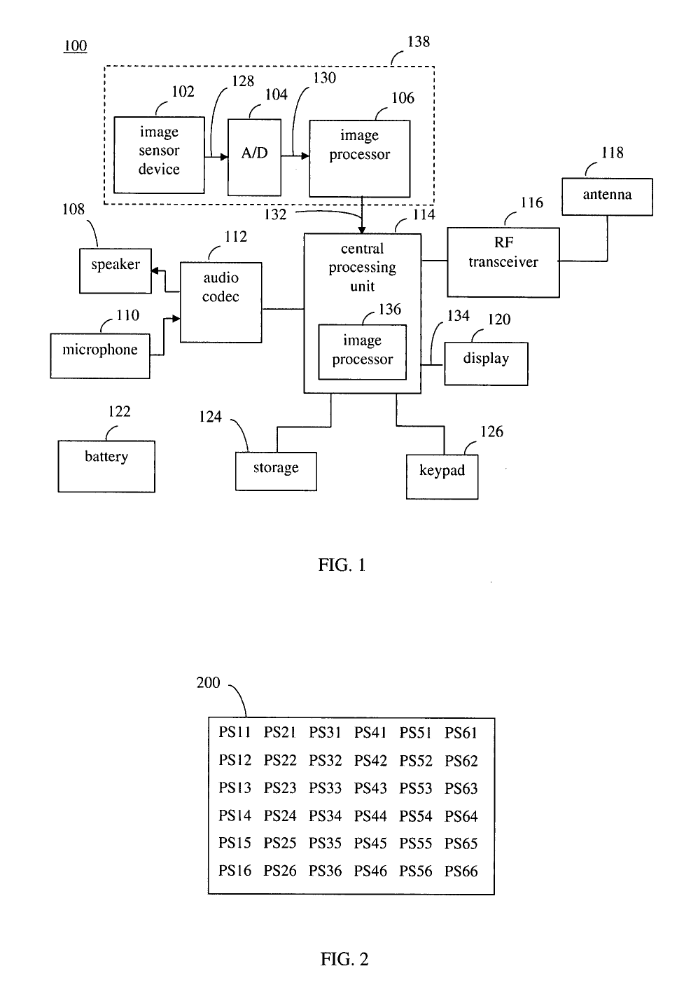

Image sensor device 102 is an image capturing device. For example, image sensor device 102 may include an array of photoelectric light sensors, such as a charge coupled device (CCD) or a CMOS (complementary metal-oxide-semiconductor) sensor device. Image sensor device 102 typically includes a two-dimensional array of sensor elements organized into rows and columns. For example, FIG. 2 shows a sensor array 200, which is an example of image sensor device 102, having a two-dimensional array of pixel sensors (PS). Sensor array 200 is shown in FIG. 2 as a six-by-six array of thirty-six (36) pixel sensors for ease of illustration. Sensor array 200 may have any number of pixel sensors, including hundreds of thousands or millions of pixel sensors. Each pixel sensor is shown in FIG. 2 as “PSxy”, where “x” is a row number, and “y” is a column number, for any pixel sensor in the array of sensor elements. In embodiments, each pixel sensor of image sensor device 102 is configured to be sensitive to a specific color, or color range. In one example, three types of pixel sensors are present, including a first set of pixel sensors that are sensitive to the color red, a second set of pixel sensors that are sensitive to green, and a third set of pixel sensors that are sensitive to blue. Image sensor device 102 receives light corresponding to an image, and generates an analog image signal 128 corresponding to the captured image. Analog image signal 128 includes analog values for each of the pixel sensors.

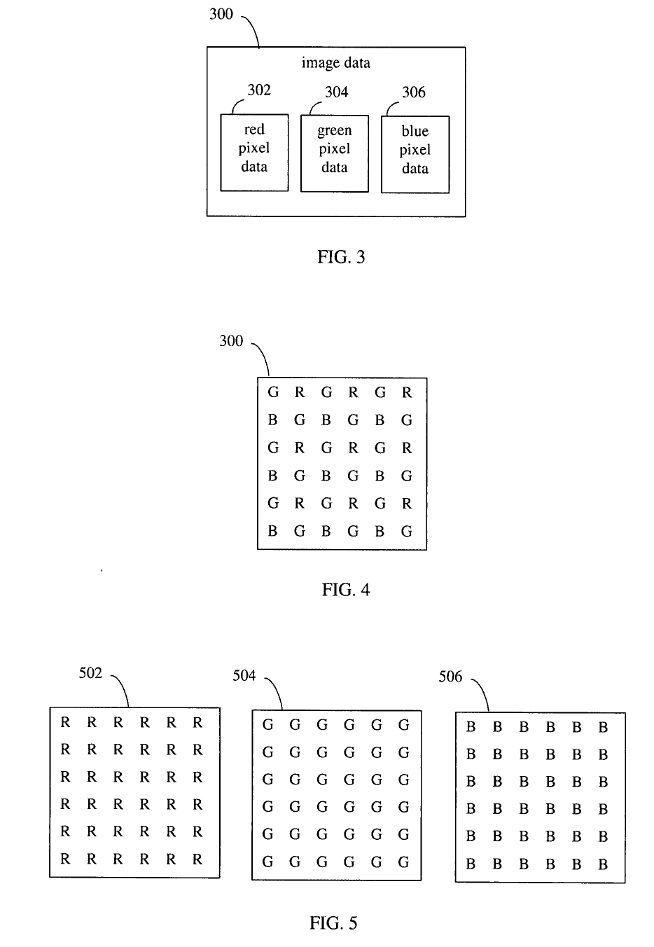

A/D 104 receives analog image signal 128, converts analog image signal 128 to digital form, and outputs a digital image signal 130. Digital image signal 130 includes digital representations of each of the analog values generated by the pixel sensors, and thus includes a digital representation of the captured image. For instance, FIG. 3 shows a block diagram representation of image data 300 included in digital image signal 130 for an image captured by image sensor device 102. As shown in FIG. 3, image data 300 includes red pixel data 302, green pixel data 304, and blue pixel data 306. Red pixel data 302 includes data related to pixel sensors of image sensor device 102 that are sensitive to the color red. Green pixel data 304 includes data related to pixel sensors of image sensor device 102 that are sensitive to the color green. Blue pixel data 306 includes data related to pixel sensors of image sensor device 102 that are sensitive to the color blue.

FIG. 4 illustrates image data 300 in array form, as captured by image sensor 102. In FIG. 4, “R” represents red pixel data captured by a corresponding pixel sensor of image sensor device 102, “G” represents green pixel data captured by a corresponding pixel sensor of image sensor device 102, and “B” represents blue pixel data captured by a corresponding pixel sensor of image sensor device 102. Referring back to FIG. 2, alternating pixel sensors PS11, PS31, and PS51 of the first row of sensor array 200 may be sensitive to green light, and thus may correspond to a “G” in FIG. 4, having generated green light data. Alternating pixel sensors PS21, PS41, and PS61 of the first row of sensor array 200 may be sensitive to red light, and thus may correspond to an “R” in FIG. 4, having generated red light data. In the second row of sensor array 200, alternating pixel sensors PS12, PS32, and PS52 may be sensitive to blue light, and thus may correspond to a “B” in FIG. 4, having generated blue light data. Alternating pixel sensors PS22, PS42, and PS62 of the second row of sensor array 200 may be sensitive to green light, and thus may correspond to a “G” in FIG. 4, having generated green light data. The color pattern of the first and second rows of sensor array 200 shown in FIG. 4 may be repeated in sensor array 200 for subsequent rows, as shown in FIG. 4.

The pixel pattern shown for image data 300 in FIG. 4 is called a Bayer pattern image. A Bayer filter mosaic is a color filter array (CFA) for arranging RGB color filters on the array of pixel sensors in image sensor device 102 to generate the Bayer pattern image. The Bayer pattern arrangement of color filters is used in many image sensors of devices such as digital cameras, camcorders, scanners, and mobile devices to create a color image. The filter pattern is 50% green, 25% red and 25% blue, hence is also referred to as “RGBG” or “GRGB.” The green pixel sensors are referred to as “luminance-sensitive” elements, and the red and blue pixel sensors are referred to as “chrominance-sensitive” elements. Twice as many green pixel sensors are used as either of the red or blue pixel sensors to mimic the greater resolving power of the human eye with green light wavelengths. Alternatives to the Bayer pattern image may also be used, which include the CYGM filter (cyan, yellow, green, magenta) and RGBE filter (red, green, blue, emerald), which require demosaicing, and the Foveon X3 sensor, which layers red, green, and blue sensors vertically rather than using a mosaic.

Image processor 106 receives digital image signal 130. Image processor 106 performs image processing of the digital pixel sensor data received in digital image signal 130. For example, image processor 106 may be used to generate pixels of all three colors at all pixel positions when a Bayer pattern image is output by image sensor device 102. Image processor 106 may perform a demosaicing algorithm to interpolate red, green, and blue pixel data values for each pixel position of the array of image data 200 shown in FIG. 4. For example, FIG. 5 shows a red color channel 502, a green color channel 504, and a blue color channel 506 generated by image processor 106 from image data 300. Each of red, green, and blue color channels 502, 504, and 506 includes a full array of image data for red, green, and blue, respectively, generated from image data 300 of FIG. 3. In other words, red color channel 502 includes a full array of red pixel data values, where a red pixel data value is generated for the position of each “G” and “B” pixel data value shown for image data 300 in FIG. 4, such as by averaging the values of the surrounding existing “R” pixel data values. In a likewise manner, a full array of green pixel data values is generated for green color channel 504 and a full array of blue pixel data values is generated for blue color channel 504. Thus, each of red, green, and blue color channels 502, 504, and 506 is an array of data values the size of the array of image data 300 shown in FIG. 4.

Image processor 106 performs processing of digital image signal 130, such as described above, and generates an image processor output signal 132. Image processor output signal 132 includes processed pixel data values that correspond to the image captured by image sensor device 102. Image processor output signal 132 includes color channels 502, 504, and 506, which each include a corresponding full array of pixel data values, respectively representing red, green, and blue color images corresponding to the captured image.

Note that in an embodiment, two or more of image sensor device 102, A/D 104, and image processor 106 may be included together in a single IC chip, such as a CMOS chip, particularly when image sensor device 102 is a CMOS sensor, or may be in two or more separate chips. For instance, FIG. 1 shows image sensor device 102, A/D 104, and image processor 106 included in a camera module 138, which may be a single IC chip in an example embodiment.

CPU 114 is shown in FIG. 1 as coupled to each of image processor 106, audio codec 112, RF transceiver 116, display 120, storage 124, and keypad 126. CPU 114 may be individually connected to these components, or one or more of these components may be connected to CPU 114 in a common bus structure.

Microphone 110 and audio CODEC 112 may be present in some applications of mobile device 100, such as mobile phone applications and video applications (e.g., where audio corresponding to the video images is recorded). Microphone 110 captures audio, including any sounds such as voice, etc. Microphone 110 may be any type of microphone. Microphone 110 generates an audio signal that is received by audio codec 112. The audio signal may include a stream of digital data, or analog information that is converted to digital form by an analog-to-digital (A/D) converter of audio codec 112. Audio codec 112 encodes (e.g., compresses) the received audio of the received audio signal. Audio codec 112 generates an encoded audio data stream that is received by CPU 114.

CPU 114 receives image processor output signal 132 from image processor 106 and receives the audio data stream from audio codec 112. As shown in FIG. 1, CPU 114 includes an image processor 136. In embodiments, image processor 136 performs image processing (e.g., image filtering) functions for CPU 114. In an embodiment, CPU 114 includes a digital signal processor (DSP), which may be included in image processor 136. When present, the DSP may apply special effects to the received audio data (e.g., an equalization function) and/or to the video data. CPU 114 may store and/or buffer video and/or audio data in storage 124. Storage 124 may include any suitable type of storage, including one or more hard disc drives, optical disc drives, FLASH memory devices, etc. In an embodiment, CPU 114 may stream the video and/or audio data to RF transceiver 116, to be transmitted from mobile device 100.

When present, RF transceiver 116 is configured to enable wireless communications for mobile device 116. For example, RF transceiver 116 may enable telephone calls, such as telephone calls according to a cellular protocol. RF transceiver 116 may include a frequency up-converter (transmitter) and down-converter (receiver). For example, RF transceiver 116 may transmit RF signals to antenna 118 containing audio information corresponding to voice of a user of mobile device 100. RF transceiver 116 may receive RF signals from antenna 118 corresponding to audio information received from another device in communication with mobile device 100. RF transceiver 116 provides the received audio information to CPU 114. In another example, RF transceiver 116 may be configured to receive television signals for mobile device 100, to be displayed by display 120. In another example, RF transceiver 116 may transmit images captured by image sensor device 102, including still and/or video images, from mobile device 100. In another example, RF transceiver 116 may enable a wireless local area network (WLAN) link (including an IEEE 802.11 WLAN standard link), and/or other type of wireless communication link.

CPU 114 provides audio data received by RF transceiver 116 to audio codec 112. Audio codec 112 performs bit stream decoding of the received audio data (if needed) and converts the decoded data to an analog signal. Speaker 108 receives the analog signal, and outputs corresponding sound.

Image processor 106, audio codec 112, and CPU 114 may be implemented in hardware, software, firmware, and/or any combination thereof. For example, CPU 114 may be implemented as a proprietary or commercially available processor, such as an ARM (advanced RISC machine) core configuration, that executes code to perform its functions. Audio codec 112 may be configured to process proprietary and/or industry standard audio protocols. Image processor 106 may be a proprietary or commercially available image signal processing chip, for example.

Display 120 receives image data from CPU 114, such as image data generated by image processor 106. For example, display 120 may be used to display images captured by image sensor device 102. Display 120 may include any type of display mechanism, including an LCD (liquid crystal display) panel or other display mechanism.

Depending on the particular implementation, image processor 106 formats the image data output in image processor output signal 132 according to a proprietary or known video data format. Display 120 is configured to receive the formatted data, and to display a corresponding captured image. In one example, image processor 106 may output a plurality of data words, where each data word corresponds to an image pixel. A data word may include multiple data portions that correspond to the various color channels for an image pixel. Any number of bits may be used for each color channel, and the data word may have any length.

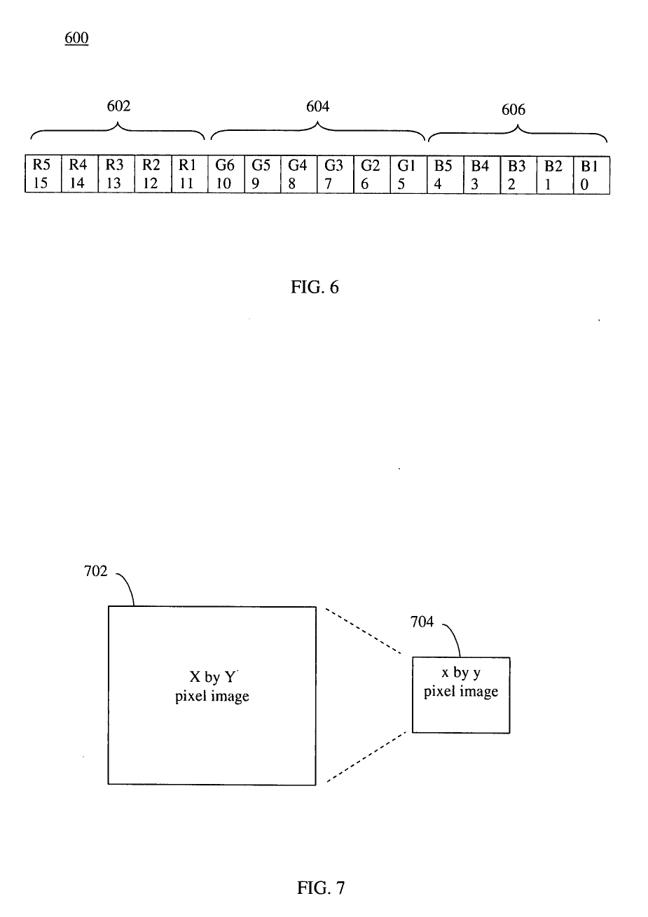

For instance, in one standard implementation, the data word may be a 24-bit data word that includes 8 bits for the red color channel, 8 bits for the green color channel, and 8 bits for the blue color channel. In another standard implementation, as shown in FIG. 6, a data word 600 generated by image processor 106 may include 16-bits to represent an image pixel. As shown in FIG. 6, data word 600 includes 5 bits for the red color channel (R1-R5), shown as word portion 602, 6 bits for the green color channel (G1-G6), shown as word portion 604, and 5 bits for the blue color channel (B5-B1) shown as word portion 606. Word portion 602 (red) is packed in data word 600 as the highest order bits, word portion 604 (green) forms the middle order bits, and word portion 606 (blue) forms the lowest order bits. Note that these data word examples are provided for purposes of illustration, and that any data word format may be accommodated by embodiments of the present invention.

In some implementations, display 120 has a display screen that is not capable of viewing the full resolution of the images captured by image sensor device 102. Image sensor devices 102 may have various sizes, including numbers of pixels in the hundreds of thousand, or millions, such as 1 megapixel (Mpel), 2 Mpels, 4 Mpels, 8 Mpels, etc.). Display 120 may be capable of displaying relatively smaller image sizes. In one example, an image captured by image sensor device 102 may be 640 pixels by 480 pixels in size (307,200 pixels). In contrast, a display screen of display 120 may be 128 pixels by 96 pixels in size (12,288 pixels). Thus, display 120 (having a 12,288 pixel screen size) is not capable of displaying the entire captured image (having 307,200 pixels) at once.

To accommodate such differences between a size of display 120 and a size of captured images, CPU 114 (e.g., image processor 136) must down-size a captured image received from image processor 106 before providing the image to display 120. This is illustrated in FIG. 7, where an X by Y pixel image 702, captured by an image sensor, must be down-sized to an x by y pixel image 704, for display on the relatively small display screen of display 120 of mobile device 100. In the current example, CPU 114 must down-size the captured image by 25 times (307,200/12,288).

Such image downsizing may be performed by a subsampling process. In computer graphics, subsampling is a process used to reduce an image size. Subsampling is a type of image scaling, and may alter the appearance of an image or reduce the quantity of information required to store an image. Two types of subsampling are replacement and interpolation. The replacement technique selects a single pixel from a group and uses it to represent the entire group. The interpolation technique uses a statistical sample of the group (such as a mean) to create a new representation of the entire group.

In a subsampling process used in the current example, a captured image pixel array of 307,200 pixel data values may be divided into a plurality of sections having 25 pixels each. An averaging function can be performed on the 25 pixel data values of each section to generate a single representative pixel for display for each section. In this manner, an averaged pixel is generated for each section of 25 pixels, creating an image of 12,288 averaged pixels for display by display 120. However, performing an averaging function on 25 pixel data values requires a large number of operations. For example, the following equation (Equation 1) represents an averaging function for a number P of pixels:

$$Average = {\sum }_{i = 1}^{P} {a}_{i} P {S}_{i} \qquad Equation 1$$

where:
aᵢ=scaling/weighting factor for the ith pixel, and
PSᵢ=pixel data value the ith pixel.
   For the current example of P=25 pixels, each aᵢ may be equal to 1/25 for uniform averaging. In one implementation, a total of 49 operations must be performed to determine an average, including 25 multiplication operations and 24 addition operations. Each multiplication and addition operation may take more than one CPU cycle, leading to a fairly large number of operations required to process a single pixel data value. Furthermore, this averaging function must be performed 12,288 times to generate 12,288 average pixels. Still further, this averaging operation must be performed for every captured image frame in a captured video stream. Encoding and decoding (e.g., QCIF) functions may also need to be performed by CPU 114 on the video data, at frame rates such as 15 fps and 30 fps, respectively, as well as performing other functions required by CPU 114. The processing of captured images greatly adds to the workload of CPU 114.

To handle the increased processing load, mobile devices 100 typically are provided with high performance CPUs and/or special purpose image processing chips, which are expensive and consume greater amounts of power, in an undesired manner. Embodiments of the present invention overcome deficiencies of conventional mobile devices. Embodiments enable the down-sizing and display of captured images on mobile devices, while reducing CPU performance and power consumption requirements. Example embodiments are described in the following section.

### EXAMPLE EMBODIMENTS

The example embodiments described herein are provided for illustrative purposes, and are not limiting. The examples described herein may be adapted to any type of mobile device. Furthermore, additional structural and operational embodiments, including modifications/alterations, will become apparent to persons skilled in the relevant art(s) from the teachings herein.

Embodiments relate to filtering operations performed on captured image data. In particular, embodiments relate to devices where images are captured by an image sensor, and the resulting array of captured image data is output by the image sensor in a multi-color, standard image data format (e.g., Bayer pattern). In such devices, the array of standard format image data is typically processed into multiple separate arrays, with each separate array directed to a different color. Embodiments of the present invention perform filtering operations on the multiple arrays in an efficient manner. For example, as described in further detail below, selected pixel data in the multiple arrays is not used (e.g., is ignored, discarded, etc.) during the filtering operations. As a result, the filtering operations can be performed on fewer pixel data values, and therefore require fewer calculations, with an outcome that is equal to or even better in quality than for conventional filtering operations.

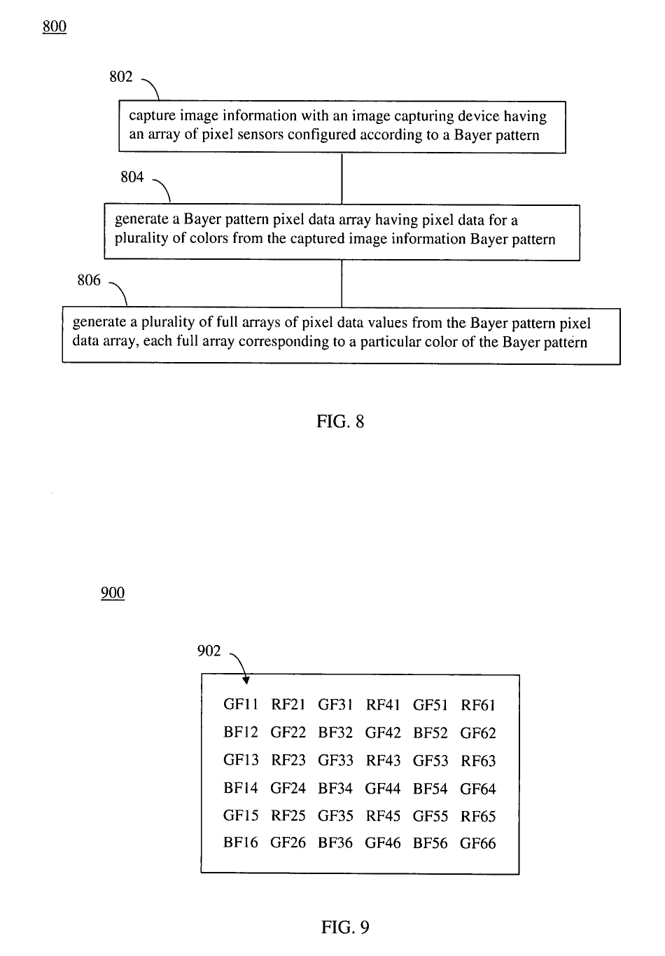

For example, embodiments relate to devices having image capturing devices and image processors such as image sensor 102 and image processor 106 of FIG. 1. Image sensor 102 may capture image data in a standard format, and image processor 106 may process the captured image data into multiple arrays of image data. FIG. 8 shows a flowchart 800 providing example steps for capturing and processing image data into multiple arrays. FIG. 8 is described with respect to FIG. 9 for illustrative purposes, as follows.

Flowchart 800 begins with step 802. In step 802, image information is captured with an image capturing device having an array of pixel sensors configured according to a Bayer pattern. For instance, FIG. 1 shows image sensor device 102, which has an array of pixel sensors, such as pixel sensors PS11-PS66 shown in FIG. 2 for image sensor 200. Pixel sensors of image sensor device 102 may be configured according to a Bayer pattern, to capture image data in a Bayer image pattern, such as shown in FIG. 4. To generate a Bayer pattern image, pixel sensors PS11-PS66 of image sensor 200 may have an associated Bayer color filter array (CFA). FIG. 9 shows an example Bayer CFA 900 which may be used to generate image data according to a Bayer pattern. As shown in FIG. 9, Bayer CFA 900 includes a color filter (RF, GF, or BF) at each spatial location, to form an array 902 of color filters. Color filters are labeled with an “RF” to indicate a red filter, with a “GF” to indicate a green filter, and with a “BF” to indicate a blue filter. The “x” and “y” coordinates of each color filter is indicated by the trailing two digits. Bayer CFA 900 is shown in FIG. 9 as a 6 by 6 array for ease of illustration. Bayer CFA 900 may include color filters arranged in an array of any size, as desired for a particular application.

Bayer CFA 900 may be used with image sensor 200 to generate image data according to a Bayer pattern. Each color filter of Bayer CFA 900 filters a respective pixel sensor PS of image sensor 200 to output red, green, or blue pixel image information. For example, green filters GF 11, GF31, and GF51 may be used to respectively filter an output of pixel sensors PS11, PS31, and PS51 of the first row of image sensor 200, to generate green output pixel information for pixel sensors PS11, PS31, and PS51. Red filters RF21, RF41, and RF61 may be used to respectively filter an output of pixel sensors PS21, PS41, and PS61 of the first row of image sensor 200, to generate red output pixel information for pixel sensors PS21, PS41, and PS61. Blue filters BF12, BF32, and BF52 may be used to respectively filter an output of pixel sensors PS12, PS32, and PS52 of the second row of image sensor 200, to generate blue output pixel information for pixel sensors PS12, PS32, and PS52. In this manner, the color filters of Bayer CFA 900 may filter all of the pixel sensors of image sensor 200 to capture an array of pixel information in a Bayer pattern.

In step 804, a Bayer pattern pixel data array is generated from the captured image information. For example, A/D 104 shown in FIG. 1, when present, may convert the image information captured by image sensor 200 and filtered by Bayer CFA 900 into discrete (digital) signal form, generating a Bayer pattern pixel data array. For example, image data 300 shown in FIG. 4 is a Bayer pattern pixel data array. As shown in FIG. 4, the Bayer pattern pixel data array includes pixel data for a plurality of colors (e.g., red, green, and blue) arranged according to the Bayer pattern.

In step 806, a plurality of full arrays of pixel data values is generated from the Bayer pattern pixel data array, each full array corresponding to a particular color of the Bayer pattern. For instance, as described above, image processor 106 may receive image data 300, and generate red, green, and blue color channels 502, 504, and 506 from image data 300. Red, green, and blue color channels 502, 504, and 506 are full arrays of pixel data values for their respective colors. Image processor 106 may generate red, green, and blue color channels 502, 504, and 506 from image data 300 in various ways.

As shown in FIG. 4, image data 300 includes red (R), green (G), and blue (B) pixel data values. One half of the pixel data values are green, one fourth of the pixel data values are red, and one fourth of the pixel data values are blue. Image processor 106 generates full arrays of pixel data values for each of the incomplete arrays of red, green, and blue pixel data values in image data 300. For example, step 806 may include the step of interpolating pixel data values of the Bayer pattern pixel data array for each color of the Bayer pattern. For example, for each green and blue location in image data 300, a red pixel data value may be generated by averaging the red pixel data values surrounding the green and blue locations, respectively. For each red and blue location in image data 300, a green pixel data value may be generated by averaging the green pixel data values surrounding the red and blue locations, respectively. For each red and green location in image data 300, a blue pixel data value may be generated by averaging the blue pixel data values surrounding the red and green locations, respectively.

According to step 806, the numbers of pixel data values in each full array is larger than the original number of pixel data values for each color in image data 300 of FIG. 4. The number of red pixel data values in red color channel 502 is quadruple the number of red pixel data values in image data 300 in FIG. 4. The number of green pixel data values in green color channel 504 is double the number of green pixel data values in image data 300 in FIG. 4. The number of blue pixel data values in blue color channel 506 is quadruple the number of blue pixel data values in image data 300 in FIG. 4.

In conventional mobile devices, the full arrays for each color may be subsequently filtered and/or otherwise processed, and then provided to a display. The full arrays for each color are generated in the manner just described because it is easier to process separate color arrays rather than processing the multi-color data content of image data 300. However, this increase in number of pixel data values for each color channel does not result in a better quality image, since no new image information related to the captured image is generated by producing the additional pixels of each array.

Embodiments of the present invention do not use (e.g., ignore/discard) the additional pixel data values generated from a Bayer pattern to create full arrays for each color. Instead, subsequent image processing (e.g., filtering) operations are performed using the pixel data values at the same locations as those present in the original Bayer image sampling pattern. In this manner, the number of calculations required to process a captured image is reduced.

For example, in an embodiment of the present invention, fully up-sampled image data that originated from a Bayer grid sensor array is received. The up-sampled image data is generated by an image processor, such as image processor 106 shown in FIG. 1. For example, image processor 106 may perform flowchart 800 of FIG. 8 to generate the fully up-sampled image data from the Bayer pattern image data. As shown in FIG. 1, image processor 106 is located in a camera module 138, which may be a single chip or multi-chip package, or other module or device that does not physically output the original Bayer pattern data generated by the Bayer grid sensor array. Instead, camera module 138 outputs the up-sampled image data, which may be included in image processor signal 132 output from camera module 138. The fully up-sampled image data includes full arrays for each color (e.g., red, green, blue), generated from a Bayer image pattern captured by the image sensor device.

In embodiments, to reduce a number of operations to be performed on the fully up-sampled image data, the fully up-sampled image data is down-sampled to an image data set containing pixel data values positioned according to the original Bayer image pattern. The down-sampled version of the up-sampled image data has the same number of pixels, and the same spatial location distribution as that of the original Bayer image pattern. However, the down-sampled version of the up-sampled image data may not have exactly the same luminance and chromatic intensity levels as the original Bayer image pattern data, due to possible inter-pixel processing/corrections and/or other image processing that occurred when generating the up-sampled image data from the original Bayer image pattern data. Thus, the down-sampled version of the up-sampled image data is an approximation of the original Bayer image pattern data. Post processing that may be performed on the down-sampled version of the up-sampled image data will require fewer operations compared to post-processing based on the fully up-sampled image data because the down-sampled version of the up-sampled image data has fewer pixels than the fully up-sampled image data.

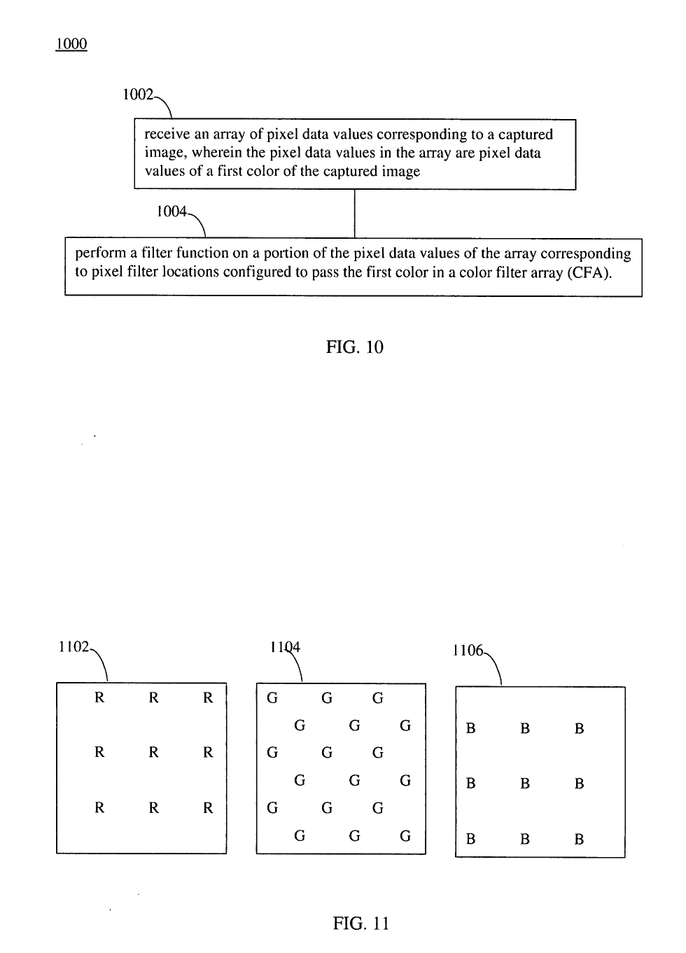

For instance, FIG. 10 shows a flowchart 1000 providing example steps for filtering a captured image in an enhanced manner, according to an example embodiment of the present invention. FIG. 10 is described with respect to FIGS. 11-14 for illustrative purposes. Other structural and operational embodiments will be apparent to persons skilled in the relevant art(s) based on the discussion regarding flowchart 1000. Flowchart 1000 is described as follows.

Flowchart 1000 begins with step 1002. In step 1002, an array of pixel data values corresponding to a captured image is received, wherein the pixel data values in the received array are pixel data values of a first color channel of the captured image. For example, the array of pixel data values that is received may be one of red, green, and blue color channels 502, 504, and 506. These color channels were generated from pixel data values arranged in a Bayer pattern, such as image data 300 shown in FIG. 4. The array received in step 1002 may be received from storage (such as storage 124 of FIG. 1), from an image processor (such as image processor 106), or from other sources.

In step 1004, a filter function is performed on a portion of the pixel data values of the array corresponding to pixel filter locations configured to pass the first color in a color filter array (CFA). The portion of pixel data values recited in step 1004 are the pixel data values of the received array that were originally present in the Bayer (or other CFA pattern) pattern from which the received array was generated, having a color that matches the color of the received array. Thus, the filter function of step 1004 is specifically performed on pixel data values in the received array corresponding to pixel filter locations in the CFA that passed the color of the received array.

FIG. 11 shows a red portion 1102, a green portion 1104, and a blue portion 1106 of pixel data values corresponding to a Bayer CFA. Red portion 1102 is the portion of a received red color channel array that was originally present in the Bayer pattern from which the received red color channel was formed. Green portion 1104 is the portion of a received green color channel array that was originally present in the Bayer pattern from which the received green color channel was formed. Blue portion 1106 is the portion of a received blue color channel array that was originally present in the Bayer pattern from which the received blue color channel was formed.

For example, if the array received in step 1002 is red color channel 502, the portion recited in step 1004 is red portion 1102, and the filter function is performed on pixel data values of red portion 1102 of received red color channel 502. Likewise, if the received array is green color channel 504, the filter function is performed on pixel data values of green portion 1104 of received green color channel 502, and if the received array is blue color channel 502, the filter function is performed on pixel data values of blue portion 1106 of received blue color channel 506.

With respect to the color red, performing the filter function on pixels of red portion 1102 of received red color channel 502, rather than on all pixels of red color channel 502, can reduce a number of calculations by a factor of one-fourth. For instance, 36 calculations may be required to process all 36 pixel data values of red color channel 502, while only 9 calculations may be required to process all 9 pixel data values of red portion 1102. This is a substantial reduction in processor workload. In a likewise manner, 36 calculations may be required to process all 36 pixel data values of green color channel 504 versus 18 calculations required to process all 18 pixel data values of green portion 1104 (reduction factor of one-half), and 36 calculations may be required to process all 36 pixel data values of blue color channel 506 versus 9 calculations required to process all 9 pixel data values of blue portion 1106 (reduction factor of one-quarter).

Note that steps 1002 and 1004 of flowchart 1000 may be repeated one or more times to filter one or more additional color channels. For example, an initial iteration of flowchart 1000 may be performed on a received full array of red pixel data values (red color channel 502), while subsequent iterations may be performed on full arrays of green and blue pixel data values (green and blue color channels 504 and 506). Furthermore, steps 1002 and 1004 of flowchart 1000 may be repeated for additional captured images in an image stream, such as captured images in a video image stream.

While flowcharts 800 and 1000 are described herein with respect to a Bayer pattern/Bayer CFA, in alternative embodiments, flowcharts 800 and 1000 may be performed with respect to other types of standard image data patterns/color filter arrays, such as the CYGM filter (cyan, yellow, green, magenta), the RGBE filter (red, green, blue, emerald), the Foveon X3 sensor filter (which layers red, green, and blue sensors vertically), and to further patterns/color filter arrays, as would be known and apparent to persons skilled in the relevant art(s) from the teachings herein.

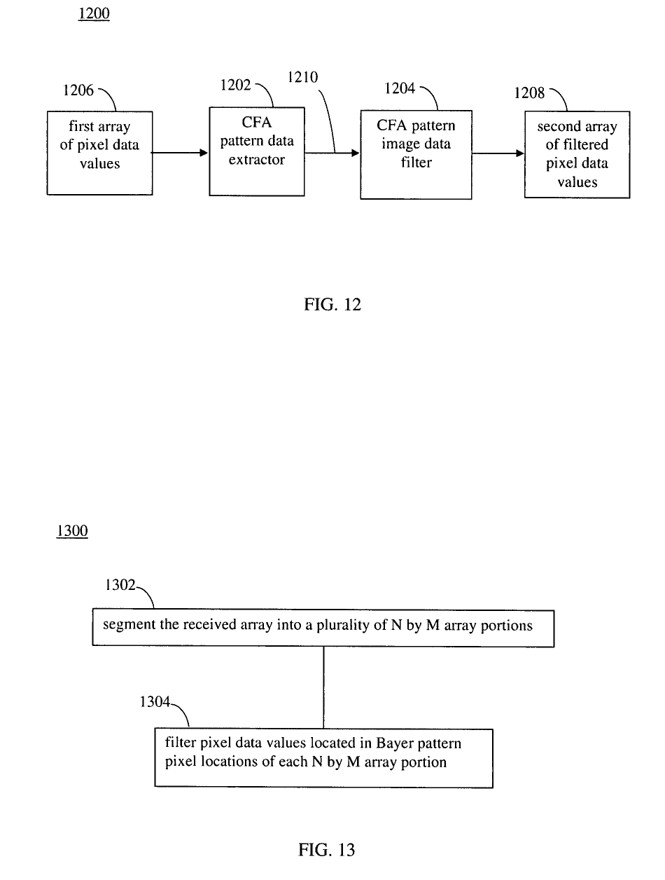

In embodiments, a device may be configured in a variety of ways to implement flowchart 1000 of FIG. 10. For example, FIG. 12 shows a block diagram of an image filtering system 1200, according to an embodiment of the present invention. System 1200 includes a CFA pattern data extractor 1202 and a CFA pattern image data filter 1204. CFA pattern data extractor 1202 and CFA pattern image data filter 1204 may be implemented in hardware, software, firmware, or any combination thereof. For example, in an embodiment, CFA pattern data extractor 1202 and filter 1204 may be implemented as one or more blocks/modules of code that is/are executed by a processor, such as CPU 114 shown in FIG. 1. Alternatively, CFA pattern data extractor 1202 and filter 1204 may be implemented as hardware logic in an integrated circuit, such as an application specific integrated circuit (ASIC). In an embodiment, CFA pattern data extractor 1202 and filter 1204 may be implemented by image processor 136 shown in FIG. 1. System 1200 is described in further detail as follows.

CFA pattern data extractor 1202 is optionally present. When present, CFA pattern data extractor 1202 receives a first array 1206 of pixel data values (e.g., according to step 1002). First array 1206 may be received from storage (such as storage 124 of FIG. 1), from an image processor (such as image processor 106), or from other image data source. CFA pattern data extractor 1202 extracts CFA pattern pixel data, such as Bayer pattern pixel data, from first array 1206 of the color matching the color channel represented by first array 1206. For example, if first array 1206 is a red color channel, CFA pattern data extractor 1202 extracts the Bayer pattern red pixel data (e.g., red portion 1102) from first array 1206. If first array 1206 is a green color channel, CFA pattern data extractor 1202 extracts the Bayer pattern green pixel data (e.g., green portion 1104) from first array 1206. If first array 1206 is a blue color channel, CFA pattern data extractor 1202 extracts the Bayer pattern blue pixel data (e.g., blue portion 1106) from first array 1206.

CFA pattern data extractor 1202 outputs the extracted Bayer pattern pixel data values as extracted array portion 1210. In an embodiment, extracted array portion 1210 is stored in storage (such as storage 124 of FIG. 1). In another embodiment, extracted array portion 1210 is not stored.

In an embodiment, CFA pattern image data filter 1204 receives extracted array portion 1210 (e.g., from CFA pattern data extractor 1202 as shown in FIG. 12, or from storage). CFA pattern image data filter 1204 performs a filtering function (including one or a combination or filtering functions) on the Bayer pattern pixel data values in extracted array portion 1210 (e.g., according to step 1004). By performing the filtering function on the Bayer pattern pixel data values in extracted array portion 1210, rather than on the entirety of first array 1206, a number of required calculations is reduced.

In another embodiment, data extractor 1202 is not present. In such an embodiment, CFA pattern image data filter 1204 receives first array 1206 (e.g., according to step 1002) without the Bayer pattern data first being extracted. In such an embodiment, image data filter 1204 is configured to perform the filtering function directly on the Bayer pattern pixel data in first array 1206 corresponding to the color channel represented by first array 1206, while ignoring other (non-Bayer pattern) data in first array 1206.

Image data filter 1204 generates a second array 1208, which includes filtered pixel data values based on a filtering of the Bayer pattern data of first array 1206. The filtering function performed by image data filter 1204 may operate on a portion or all of the pixel data values of the Bayer pattern data of the relevant color. Second array 1208 may have a larger size, a same size, or a smaller size than first array 1206, depending on the particular filter function performed by image data filter 1204.

For example, in an embodiment, image data filter 1204 is configured to perform an up-scaling function on first array 1206 to generate second array 1208. In such an embodiment, second array 1208 is generated to have a larger size than first array 1206. Filter 1204 generates an up-scaled version of first array 1206 by filtering the Bayer pattern pixel data of first array 1206 to an increased number of pixel data values. For example, the filter function may be an interpolation function, where new pixel data values are generated between existing Bayer pattern pixel data values of the relevant color, by averaging nearby Bayer pattern pixel data values of the relevant color.

In another embodiment, CFA pattern image data filter 1204 is configured to perform a down-scaling function on first array 1206 to generate second array 1208. In such an embodiment, second array 1208 is generated to have a smaller size than first array 1206. In one embodiment, filter 1204 generates a down-scaled version of first array 1206 by filtering, or directly passing unfiltered, just the Bayer pattern pixel data of first array 1206 of the relevant color without changing the number of pixel data values. In another embodiment, filter 1204 generates a down-scaled version of first array 1206 by filtering the Bayer pattern pixel data of first array 1206 of the relevant color to a decreased number of pixel data values. In still another embodiment, 1204 generates a down-scaled version of first array 1206 by filtering the Bayer pattern pixel data of first array 1206 of the relevant color to an increased number of pixel data values, while keeping the increased number of pixel data values below the total number of pixel data values in first array 1206.

In an embodiment, a subsampling process may be used by filter 1204 to down-scale first array 1206 to generate second array 1208, such as is described further above. An example subsampling process for filter 1204 is described as follows, with respect to FIG. 13. FIG. 13 shows a flowchart 1300 providing example steps for subsampling an array of pixel data values, such as first array 1206, to generate a down-scaled array, according to an embodiment of the present invention. Flowchart 1300 is described as follows.

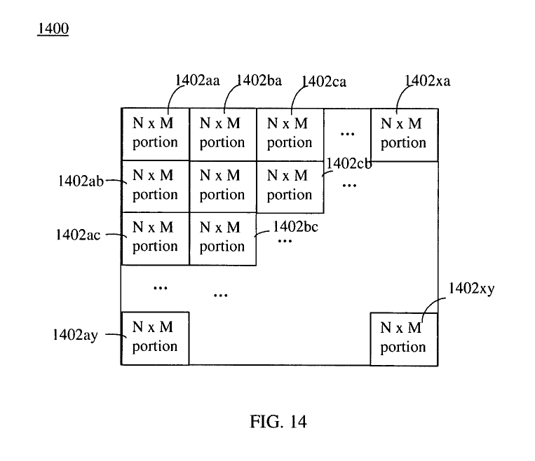

Flowchart 1300 begins with step 1302. In step 1302, the received array is segmented into a plurality of N by M array portions. For example, FIG. 14 shows a block diagram of an array 1400 of pixel data values, which is an example of first array 1206. In FIG. 14, array 1400 is segmented into a plurality of N by M array portions 1402aa-1402xy. Each N by M array portion 1402 of the plurality of N by M array portions 1402aa-1402xy includes a corresponding plurality of pixel data values. In embodiments, N and M may be equal (i.e., square array portions), or may not be equal (i.e., rectangular array portions).

In step 1304, pixel data values located in Bayer pattern pixel locations of each N by M array portion are filtered. A filtering function may be applied to each N by M array portion 1402 to generate a respective filtered pixel data value for each N by M array 1402. The array of filtered pixel data values generated for all of N by M arrays 1402aa-1402xy forms second array 1208. The filtering function applied to an N by M array portion 1402 uses one or more of the Bayer pattern pixel locations of the N by M array portion, and does not use the non-Bayer pattern pixel locations of the N by M array portion. In embodiments, the same filtering function may be applied by filter 1204 to each N by M array portion 1402, or different filtering functions may be applied to different N by M array portions 1402.

Filter 1204 may apply further types of filtering functions to Bayer pattern pixel locations of first array 1204, as would be known to persons skilled in the relevant art(s). For example, filter 1204 may apply a de-rotation function to Bayer pattern pixel locations of first array 1204. A de-rotation function may be used to rotate captured images level with the horizon (to eliminate effects of camera tilting). The de-rotation function is performed on the portion of the pixel data values of the first array 1204 that are located in Bayer pattern pixel locations for the particular color of first array 1204.

In another example, filter 1204 may apply a de-jitter function to Bayer pattern pixel locations of first array 1204. A de-jitter function may be used to align captured images to remove jitter (to eliminate effects of camera motion). The de-jitter function is performed on the portion of the pixel data values of the first array 1204 that are located in Bayer pattern pixel locations for the particular color of first array 1204.

Note that while image filtering system 1200 is described herein with respect to a Bayer pattern/Bayer CFA, in alternative embodiments, image filtering system 1200 may be adapted to function (e.g., filter) with regard to other types of patterns/color filter arrays, such as the CYGM filter (cyan, yellow, green, magenta), the RGBE filter (red, green, blue, emerald), the Foveon X3 sensor filter (which layers red, green, and blue sensors vertically), and further patterns/color filter arrays, as would be known and apparent to persons skilled in the relevant art(s) from the teachings herein.

### EXAMPLE SOFTWARE EMBODIMENTS

In this document, the terms “computer program medium” and “computer usable medium” are used to generally refer to media such as a removable storage unit, a hard disk installed in hard disk drive, and signals (i.e., electronic, electromagnetic, optical, or other types of signals capable of being received by a communications interface). These computer program products are means for providing software to a computer system and to storing software in a computer system or other device. The invention, in an embodiment, is directed to such computer program products.

In an embodiment where aspects of the present invention are implemented using software/firmware, the software/firmware may be stored in a computer program product and loaded into a computer system or other device using a removable storage drive, hard drive, or communications interface. The computer system or other device may execute the software/firmware from storage such as a hard drive or memory device (e.g., a ROM device such as an electrically erasable ROM, electrically programmable ROM, a RAM device such as a static RAM, dynamic RAM, etc.). This control logic software/firmware, when executed by a processor, causes the processor to perform the functions of the invention as described herein.

According to an example embodiment, a mobile device may execute computer-readable instructions to receive, extract, and/or filter image data, as further described elsewhere herein (e.g., as described with respect to flowcharts 800, 1000, and 1300, or FIGS. 8, 10, and 13, respectively), and as recited in the claims appended hereto.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method for filtering captured image data, comprising:
receiving an array of pixel data values corresponding to a captured image, wherein the pixel data values in the array are pixel data values of a first color of the captured image; and
performing a filter function on a portion of the pixel data values of the array corresponding to pixel filter locations configured to pass the first color in a color filter array (CFA).

2. The method of claim 1, wherein the CFA is a Bayer CFA.

3. The method of claim 2, further comprising:
capturing image information with an image capturing device having an array of pixel sensors configured according to the Bayer CFA;
generating a Bayer pattern pixel data array from the captured image information, the Bayer pattern pixel data array including pixel data for a plurality of colors arranged according to the Bayer pattern; and
generating a plurality of full arrays of pixel data values from the Bayer pattern pixel data array, each full array corresponding to a particular color of the Bayer pattern;
wherein said receiving step comprises:
receiving one of the plurality of full arrays of pixel data values as the array of pixel data values corresponding to the captured image.

4. The method of claim 1, further comprising:
receiving a second array of pixel data values corresponding to the captured image, wherein the pixel data values of the second array are pixel data values of a second color of the captured image; and
performing the filter function on a portion of the pixel data values of the second array corresponding to pixel filter locations configured to pass the second color in the CFA.

5. The method of claim 1, further comprising:
receiving a second array of pixel data values corresponding to a second captured image in a video stream, wherein the pixel data values of the second array are pixel data values of the first color of the second captured image; and
performing the filter function on a portion of the pixel data values of the second array corresponding to pixel filter locations configured to pass the first color in the CFA.

6. The method of claim 1, wherein the filter function is a down-scaling function, wherein said performing comprises:
performing a down-scaling function on the portion of the pixel data values of the array corresponding to the pixel filter locations configured to pass the first color in the CFA.

7. The method of claim 1, wherein the filter function is a de-rotation function, wherein said performing comprises:
performing a de-rotation function on the portion of the pixel data values of the array corresponding to the pixel filter locations configured to pass the first color in the CFA.

8. The method of claim 1, wherein the filter function is a de-jitter function, wherein said performing comprises:
performing a de-jitter function on the portion of the pixel data values of the array corresponding to the pixel filter locations configured to pass the first color in the CFA.

9. The method of claim 1, wherein said performing comprises:
segmenting the array into a plurality of N by M array portions so that each N by M array portion of the plurality of N by M array portions includes a corresponding plurality of pixel data values; and
filtering a portion of the pixel data values of each N by M array portion of the array corresponding to the pixel filter locations configured to pass the first color in the CFA.

10. The method of claim 1, further comprising:
extracting from the array the portion of the pixel data values of the array that corresponds to the pixel filter locations configured to pass the first color in the CFA; and
storing the extracted portion of the pixel data values;
wherein said performing step comprises:
performing the filter function on the stored extracted portion of the pixel data values.

11. The method of claim 1, wherein the CFA is one of a cyan yellow green magenta (CYGM) filter array, a red green blue emerald (RGBE) filter array, or a Foveon X3 sensor filter array.

12. The method of claim 1, wherein said performing step comprises:
discarding pixel data values of the array other than those of the portion of the pixel data values of the array corresponding to pixel filter locations configured to pass the first color in a color filter array (CFA).

13. An image filtering system, comprising:
a data extractor configured to receive an array of pixel data values corresponding to a captured image, wherein the pixel data values in the array are pixel data values of a first color of the captured image, wherein the data extractor is configured to extract a portion of the pixel data values of the array corresponding to pixel filter locations configured to pass the first color in a color filter array (CFA); and
an image data filter configured to perform a filter function on the extracted portion of the pixel data values of the array.

14. The system of claim 13, wherein the CFA is a Bayer CFA.

15. The system of claim 14, further comprising:
an image capturing device configured to capture image information, the image capturing device having an array of pixel sensors configured according to the Bayer CFA;
an analog-to-digital converter configured to receive the captured image information, and to generate a Bayer pattern pixel data array having pixel data for a plurality of colors arranged according to a Bayer pattern; and
an image processor configured to generate a plurality of full arrays of pixel data values from the Bayer pattern pixel data array, each full array corresponding to a particular color of the Bayer pattern;
wherein one of the generated plurality of full arrays of pixel data values is the received array of pixel data values corresponding to the captured image.

16. The system of claim 13, wherein the CFA is one of a cyan yellow green magenta (CYGM) filter, a red green blue emerald (RGBE) filter, or a Foveon X3 sensor filter.

17. The system of claim 13, wherein the filter function includes at least one of a down-scaling function, an up-scaling function, a de-rotation function, or a de-jitter function.

18. An image filtering system, comprising:
an image data filter configured to receive an array of pixel data values corresponding to a captured image, wherein the pixel data values in the array are pixel data values of a first color of the captured image;
wherein the image data filter is configured to perform a filter function on a portion of the pixel data values of the array corresponding to pixel filter locations configured to pass the first color in a color filter array (CFA).

19. The system of claim 18, wherein the CFA is a Bayer CFA.

20. The system of claim 19, further comprising:
an image capturing device configured to capture image information, the image capturing device having an array of pixel sensors configured according to the Bayer CFA;
an analog-to-digital converter configured to receive the captured image information, and to generate a Bayer pattern pixel data array having pixel data for a plurality of colors arranged according to a Bayer pattern; and
an image processor configured to generate a plurality of full arrays of pixel data values from the Bayer pattern pixel data array, each full array corresponding to a particular color of the Bayer pattern;
wherein the received array of pixel data values corresponding to the captured image is one of the generated plurality of full arrays of pixel data values.

21. The system of claim 18, wherein the CFA is one of a cyan yellow green magenta (CYGM) filter, a red green blue emerald (RGBE) filter, or a Foveon X3 sensor filter.

22. The system of claim 18, wherein the filter function includes at least one of a down-scaling function, an up-scaling function, a de-rotation function, or a de-jitter function.
